(19) United States
(12) Patent Application Publication
(10) Pub. No.: US 2013/0088103 A1
(43) Pub. Date: Apr. 11, 2013

(54) Synchronic Wind Turbine Generator

(71) Applicant: Enrique PESCARMONA, Godoy Cruz (AR)

(72) Inventor: Enrique PESCARMONA, Godoy Cruz (AR)

(73) Assignee: INDUSTRIAS METALURGICAS PESCARMONA S.A.I.C. Y F., Godoy Cruz (AR)

(21) Appl. No.: 13/328,853

(22) Filed: Dec. 16, 2011

(30) Foreign Application Priority Data
Oct. 5, 2011 (AR) P110103701

(51) Int. Cl. H02K 9/19; H02K 21/12

(52) U.S. Cl. 310/54; 310/198

(57) ABSTRACT

A synchronic generator comprises at least a stator and at least two windings placed opposite and parallel to its rotation axis and at least a refrigeration system. The design of this generator allows a better use of the space close to the external diameter of the generator, allowing a power increase and minimizing the weight without increasing the external diameter of the generator. Depending on wind conditions, one or both windings can work at the same time, which optimizes yield, versatility and reliability.

### FIELD OF THE INVENTION

This invention refers to a synchronic wind turbine generator of the kind used in the generation of energy by means of the wind, and more precisely this invention refers to a syncrhonic wind turbine generator which includes only one central stator with double winding.

### Prior Art

As it is known, at present, the wind energy is used mainly for producing electrical energy by means of aerogenerators. An aerogenerator is an electrical generator moved by a turbine operated by the wind (wind turbine). A conventional synchronic wind turbine generator of permanent magnets includes a stator which consists of a steel structure on which the grooved stator plates are piled up forming a ring. In the interior of the grooves of the stator plate the stator winding is placed which consists of isolated copper windings related among them forming a three-phase winding of the star type. The second component of a wind turbine generator is the rotor, which consists of a steel structure with an axis and a ring on which magnets forming North and South poles are placed, which when rotated with respect to the stator make that the lines of the magnetic field be cut by the stator windings inducing in these windings an electrical tension and an electric current offering the generator a determined electric power.

In the prior art there are a great quantity of developments which optimize to a greater or lesser extent the basic concept mentioned above. For example, U.S. Pat. No. 6,974,045 describes a wind power generating system in which a pair of axially spaced turbines are connected to an outer rotor and an inner rotor of a generator, respectively, and are provided with blades having equal but opposite pitch angles so that the inner and outer rotor rotate at a same rotational speed in opposite directions. Because the relative rotational speed between the inner and outer rotors is twice as great as the rotational speed of the inner rotor or outer rotor, the generator system can produce a relatively large electric power even when the wind speed is low. If desired, a pitch varying mechanism for the turbine blades may be done away with so as to reduce the manufacturing and maintenance costs.

On the other hand, KR Patent 20090123903(A) discloses a windmill electric-generating unit improved in generated potential because of no interference with the captured wind, unlike large-capacity generator vulnerable to the interference with the captured wind in the windmill. The permanent-magnet generator has a revolving shaft, at least three stage rotors of multiple disc constructions connected to the shaft in tandem an a lengthwise direction of the shaft and having mounted permanent magnets thereon, and stators of disc construction with stator windings of copper wires, which are isolated from the revolving shaft and laid in at least two gaps each of which is between any two adjacent rotors. The rotors and stators are arranged to alternate each other in the lengthwise direction of the shaft across five stages or more. Further, there is provided the windmill generator in which a propeller is coupled to the rotor shaft of the permanent-magnet generator constructed as stated earlier.

Further, U.S. Pat. No. 7,579,702B2 discloses an electric power converting device and power converting method for controlling doubly-fed induction generators, which provides a synchronous generator for generating auxiliary electric power independently of a doubly-fed induction generator so as to generate electricity even in a system power-free environment, a grid-side converter is composed of a three-phase four-wire converter so as to generate a balanced voltage even in an unbalanced load condition and automatically synchronize a stator voltage of a doubly-fed induction generator and a system voltage with each other. Further, JP Patent 2010207052 (A) provides a power generator capable of generating power at a predetermined voltage and a predetermined current, even if an outside energy is excessively weak or strong in generating the power using water power or wind power. SOLUTION: The generator includes a magnet rotor 24 rotating upon a rotation force from a drive source, and a stator coil 25 oppositely disposed to the magnetic pole of the magnet rotor. The magnet rotor 24 includes a rotating shaft 13 rotatably pivoted on a housing 21, and permanent magnets forming a plurality of magnetic poles on a concentric circle around at the rotating shaft. The stator coil 25 includes a plurality of coreless windings and three-phase output terminals which are disposed so as to oppose the magnetic poles formed on the rotor 24. The coreless winding includes three effective output windings or a multiple of three, and is connected to an output terminal via a switching means so that the total number of turns can be changed to be large or small. The total number of turns is made to be small when the rotation force from the drive source is large, and large when the rotation force is small

It is important to point out that US Patent 2010/0270808, which describes a wind energy apparatus is made up of a plurality of modular wind energy devices or units. Each unit has a housing and at least two turbines mounted on the housing. Each of the turbines has a blade set extending upward from the housing. Each blade set has a vertical axis extending upward in relation to the housing. Each of the turbines has a generator connected thereto, each generator being disposed in the housing, and having a rotor and a stator. Each turbine is rotatably mounted with respect to the housing, and mounted to the rotor so that they rotate together. Each housing has a positive connector and negative connector on each side of the respective unit. The units, when placed together, connect their respective poles, positive and negative, together completing a circuit. Therefore, one may connect multiple units together.

Further, U.S. Pat. No. 7,154,191 discloses that the machines useful for wind turbine and ship propulsion purposes include a double-sided generator or motor with two concentric air gaps. In one embodiment, the machine includes a double-sided rotor with an inner rotor side and an outer rotor side; and a stator with an inner stator core and an outer stator core, wherein the double-sided rotor is concentrically disposed between the inner stator core and the outer stator core.

On the other hand, U.S. Pat. No. 7,709,972 discloses a wind turbine system is provided with a wind turbine rotor, a pitch control mechanism, and an emergency power supply mechanism. The wind turbine rotor includes a blade having a variable pitch angle. The pitch control mechanism drives the blade to control the pitch angle. The emergency power supply mechanism generates electric power from rotation of the wind turbine rotor and feeds the electric power to the pitch control mechanism, in response to occurrence of an accidental drop of a system voltage of a power grid.

Also, US Patent 2008/0012347 A1 defines a wind generator system includes a stationary frame, a shaft, mechanical bearings and a stator and a rotor, along with magnetic components configured to reduce or substantially eliminate various loads imposed on the mechanical bearings by the system and by wind. In particular, magnetic components at a bearing closest to the vanes of attached to the shaft act to impart a force on the shaft opposing gravity. Magnetic components at a bearing along the shaft distal from the vanes act to impart a force on the shaft opposing a bending force exerted by the shaft on the bearing at that point. Additional magnetic components act to oppose gravity adjacent the stator and rotor. Still further magnetic components act to impart a force on the shaft opposing the wind force. Further, WO Patent 2010/099713 discloses a magnetic suspension non-friction double rotor generator consists of a central axis (2) of a generating platform, a wind turbine (1) and a water wheel turbine (10), wherein the wind turbine is coupled with an inner rotor (7) of the generator, the water wheel turbine is coupled with an outer rotor (8) of the generator. Under the action of wind power and hydraulic power, both turbines rotate in opposite directions mutually around the central axis of the generating platform and drive the inner rotor and the outer rotor of the generator to rotate in opposite directions to generate power. The generator has a reasonable structure and high generating efficiency.

### SUMMARY OF THE INVENTION

Thus, it is an object of this invention to provide a synchronic wind turbine generator of the kind used devices such as the wind turbine generators and the like, where the synchronic generator includes at least a stator and at least two windings placed opposite to each other and parallel to its rotation axis, with a magnetic induction by means of permanent magnets, and at least a refrigeration system which refrigerates both windings significantly simplifying the mechanical components and reducing the dimensions.

The refrigeration system includes a closed circuit that uses dielectric refrigeration liquid with a greater thermal stability and resistance to the oxidation than the mineral oils, of high point of ignition, eco-friendly, with fireproof properties, which circulates through channels in the interior of the stator capturing the heat emanated from both windings moving it when the oil circulates to another zone in which the room-air is dissipated by means of a radiator. The circulation of the oil is forced by a pumping system. The refrigeration is completed with a forced air circulation for removing the heat in the winding heads maintaining its circulation by means of the residual gap avoiding the overheating of the air in said zone by friction when rotating the rotor.

### DESCRIPTION OF THE FIGURES

For a better understanding of the object of this invention, the same has been illustrated in many figures, in which the same has been represented in one of the preferred embodiments, as a way of example, where:

FIG. 1 is a cross-section view of wind turbine generator object of this invention; and

FIG. 2 is a cross-section view and in detail of the wind turbine generator of FIG. 1.

### DETAILED DESCRIPTION OF THE EMBODIMENTS

The wind turbine-generator object of this invention includes at least a central stator with double winding parallel to the rotation axis. In this particular embodiment, said generator has only one stator and the same is refrigerated by at least a refrigeration system which in this particular embodiment, the system by refrigeration liquid, common to both windings, with magnetic induction by means of permanent magnets to both sides of said stator. It is important to point out that the refrigeration system to be used must not be considered as a limit to the scope of invention.

As it can be appreciated from the figures, the stator consists of a steel structure on which the stator plates are piled up, which are grooved forming a ring. In the interior of the grooves of the stator plate the winding of the stator is placed forming two rings, one for the exterior and the other for the interior of the structure. The stator winding is placed in the interior of the grooves of the stator plates forming two three-phase windings of the star type.

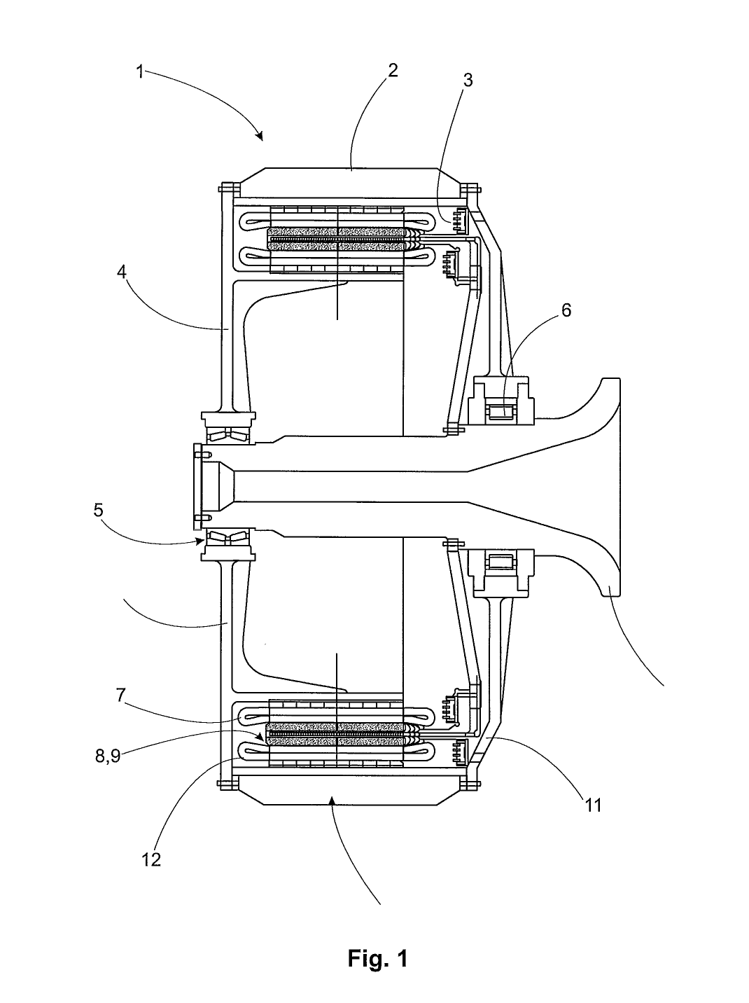

Making reference to FIG. 1, the parts composing the synchronic wind turbine generator can be seen with the general reference number 1. In fact, the generator is composed of a housing of the rotor 2, an external three-phase winding ring header 3, a radial-axial bearing 4, a front lid of the rotor 5, a radial bearing 6, an internal winding of the stator 7, a stator body and stator plates 8, a refrigeration system for both windings, a static axis 10, a back lid of the rotor 11 and an external winding of the stator 12.

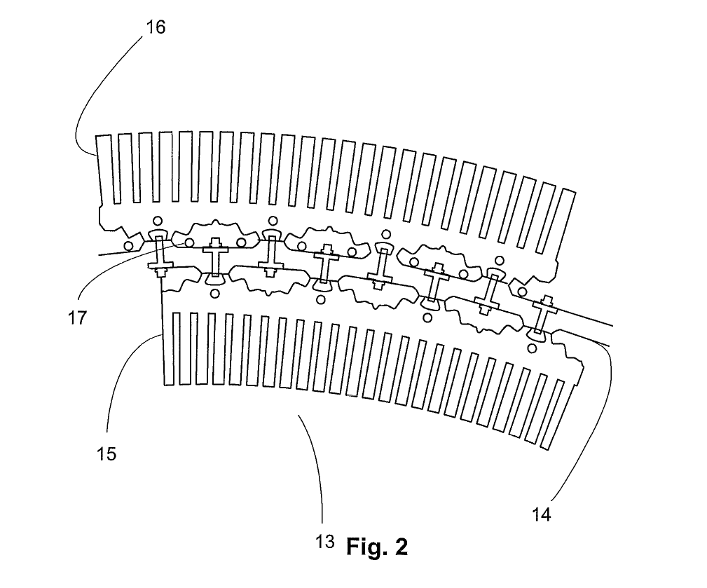

In relation to FIG. 2, in the same it can be seen the cut view of the stator of double winding indicated with the general reference number 13, which has the structure of the stator (ring) 14, on which the stator plates are placed of the internal internal and external windings 15 and 16, respectively. It is important to point out that in said structure 14 the inlet/outlet ports 17 can be seen of the refrigeration liquid.

As any person skilled in the art can determine from the mentioned above in this specification, the object of this invention will create different kinds of generators, each one with its particular characteristics, namely:
a synchronic wind turbine generator of double stator with refrigeration liquid or liquid and air or only air, with a permanent magnets of the rotor of the horizontal axis of radial magnetic flow.
a synchronic wind turbine generator of multiple concentric stators, with refrigeration liquid or liquid and air or only air, with permanent magnets of radial magnetic flow.
a synchronic wind turbine generator of multiple concentric stators, with refrigeration liquid or liquid and air or only air, with a rotor of projecting poles of radial magnetic flow.
a synchronic wind turbine generator of multiple concentric stators, with windings of superconductor material, with rotor of projecting poles, with windings of superconductor material of radial magnetic flow.
a synchronic wind turbine generator of multiple concentric stators, with windings of superconductor material, with rotor of permanent magnets of radial magnetic flow.

The design of this generator allows a better use of the space close to the external diameter of the generator allowing a power increase, minimizing the weight, without increasing the external diameter of the generator, maintaining the length, flow density and the rotating speed, which implies an advantage at the moment of the transportation from the factory to the building of the wind farm of destiny. On the other hand, an additional advantage is that depending on the wind conditions one or both windings can work or both at the same time, which optimizes its yield and versatility, also increasing its reliability since its converter adapts the energy of each winding to the network by separate or in a parallel way.

Another important advantage is that of sharing at least a refrigeration system, which reduces the spaces and structural complexity of the complete machine.

1. A synchronic generator of the kind used in devices such as wind turbine generators and the like, wherein the synchronic generator includes at least a stator and at least two windings placed opposite to each other and parallel to its rotation axis, with a magnetic induction by means of permanent magnets.

2. The generator according to claim 1, wherein said generator includes multiple concentric stators and rotor of projecting poles.

3. The generator according to claim 1, wherein said stator includes a steel structure on which the grooved stator plates are placed defining rings placed in the interior and exterior of the structure.

4. The generator according to claim 1, wherein in the grooves of said stator plates the stator winding is placed.

5. The generator according to claim 4, wherein the winding of the stator defines at least two three-phase windings of the star type.

6. The generator according to claim 1, wherein it comprises multiple concentric stators with windings of superconductor material with a rotor of permanent magnets of radial magnetic flow.

7. The generator according to claim 1, wherein it comprises at least a stator with at least a refrigeration system composed of liquid refrigerant, air or the combination of both.

8. A synchronic wind turbine generator comprising a double stator with at least a refrigeration system composed of a liquid refrigerant, air or the combination of both, with a rotor of permanent magnets of horizontal axis of radial magnetic flow.

9. A synchronic wind turbine generator comprising multiple concentric stators, with at least a refrigeration system composed of liquid refrigerant, air or the combination of both, with permanent magnets of radial magnetic flow.

10. A synchronic wind turbine generator comprising multiple concentric stators with at least a refrigeration system composed of liquid refrigerant, air or the combination of both, with rotor of projecting poles of radial magnetic flow.

11. A synchronic wind turbine generator comprising multiple concentric stators with windings of superconductor material, with rotor of projecting poles, with windings of superconductor material of radial magnetic flow.

12. A synchronic wind turbine generator comprising multiple concentric stators, with windings of superconductor material, with rotor of permanent magnets of radial magnetic flow.

13. The generator according to claim 2, wherein in the grooves of said stator plates the stator winding is placed.

14. The generator according to claim 3, wherein in the grooves of said stator plates the stator winding is placed.
